(19) United States
(12) Patent Application Publication
(10) Pub. No.: US 2012/0169061 A1
(43) Pub. Date: Jul. 5, 2012

(54) Power Generation System, Power Generator and Method Thereof

(76) Inventors: Tai Koan Lee, Sunnyvale, CA (US); Hae Sook Lee, Sunnyvale, CA (US)

(21) Appl. No.: 13/414,692

(22) Filed: Mar. 7, 2012

Related U.S. Application Data
(63) Continuation-in-part of application No. 12/560,387, filed on Sep. 15, 2009.

(51) Int. Cl. F03D 9/00; H02K 47/20

(52) U.S. Cl. 290/55; 310/113

(57) ABSTRACT

A power generation system and generator provided through a fluid flow energy source to generate electricity. The system comprising an energy source of one or more wind turbines; a motor; a transmission component comprising a pump, set of water circulators, set of water pipes, and set of transmission devices. Electricity generated from the wind turbine is adjusted, supplied to a vehicle motor, and powers the pump motor for moving water into the circulators. Another power generation system comprises unidirectional conduits for receiving an external fluid flow, a pump, a water turbine operatively connected with a transmission which is connected to a generator. In another embodiment, instead of a water turbine, one or more fluid circulators are operatively connected with a transmission which is connected to a generator. Fluid released from the pump enters a reservoir in fluid connection with a unidirectional conduit, through which fluid is pulled through the system.

### BACKGROUND

Saving resources and renewable energy are extensively discussed topics. There are constant attempts at various means to find out new energy solutions to the problems of rising prices and the imminent depletion of gasoline.

Accordingly, new solutions and improvements for power generation are needed that make it easy and affordable to implement a power generation system as well as to provide great flexibility to the user in terms of location and time.

### SUMMARY

In accordance with an embodiment of the present invention, there is a power generation system operating using an energy component of fluid flow and wind energy. The system comprising: at least one fluid circulator receiving pumped fluid at a receiving end; a fluid pump coupled to a conduit in connection to the receiving end of the fluid circulator, the pump having a receiving end for receiving the fluid released from the at least one fluid circulator, the pump operative by a motor; a transmission device operatively connected with the fluid circulator; at least one wind turbine operatively connected with the transmission device; and at least one generator operatively connected with the at least one wind turbine for generating electricity.

In another embodiment of the present invention there is a power generation system comprising: one or more conduits for unidirectional flow, each having a first end adapted for receiving a flowing fluid energy source, and each having a second end for discharge of the fluid; a fluid pump powered by a motor, the pump operatively connected at the second end of the one or more conduits, displacing the fluid through a discharge conduit; a water turbine positioned below the direction of flow of the fluid from the discharge conduit; a transmission device operatively connected with the water turbine; and a generator operatively connected with the transmission device for generating electricity. Such a system provides an efficient hydropower generation system to allow flexibility to the user in terms of location and time. The embodiment may further comprise a fluid tank having a receiving side coupled to each second end of the one or more conduits; and a fluid reservoir or pool positioned to receive the fluid flowing off from the water turbine. One or more of the conduits may be a receiving funnel capturing naturally flowing fluid into the fluid tank.

In accordance with another embodiment of the present invention there is a power generation system comprising one or more conduits for unidirectional flow, each having a first end adapted for receiving a flowing fluid energy source, and each having a second end for discharge of the fluid; at least one fluid circulator having a receiving end connected to each second end of the one or more conduits, and a discharge end; a fluid pump powered by a motor, the pump operatively connected at the discharge end of the at least one fluid circulator, the pump displacing the fluid flowing through the fluid circulator and through a discharge conduit coupled to the pump; a transmission device operatively connected with the fluid circulator; and a generator operatively connected with the transmission device for generating electricity. In the embodiment, one or more conduits may serve as a receiving funnel capturing naturally flowing fluid for discharge into the fluid circulator. The power generation system may further comprise a fluid pool positioned to receive the fluid flowing out from the fluid circulator.

Accordingly several advantages of one or more aspects of a power generation system are as follows: to provide an efficient power generation system that make better use of hydropower, whose parts and materials can be easily found, that is easy to assemble, that can easily satisfy the power supply demand for each house hold, that eliminates the cost of building grids in a new area, and that prevents added pollution to the environment.

These and other embodiments of the present invention including other advantages of one or more aspects of the present invention are further made apparent, in the remainder of the present document, to those of ordinary skill in the art.

### BRIEF DESCRIPTION OF THE DRAWINGS

In order to more fully describe embodiments of the present invention, reference is made to the accompanying drawings. These drawings are not to be considered limitations in the scope of the invention, but are merely illustrative.

FIG. 1 shows an isometric partially exploded view of a power generation system in accordance with one embodiment of the invention.

FIG. 2 is a perspective view of a power generation system in accordance with another embodiment of the present invention.

FIG. 3 is a detailed view of a pipe of FIG. 2 for connecting a pool and a fluid tank, according to an embodiment of the present invention.

FIG. 4 is a detailed partial view of the lower part of the pipe as shown in FIG. 2 with its lowest check valve, ball valve, and the pipe connected to outside fluid source, according to an embodiment of the present invention.

FIG. 5 is a perspective view of a power generation system in accordance with another embodiment of the present invention.

REFERENCE NUMBERALS

| | |
|---|---|
| 1 | reservoir |
| 2, 2A, 2B, 2C, 2D, 2J, 2S, 2V, 200 | pipe segments |
| 2P | a combination of pipe segments and |
| | valves |
| 5A, 5B, 5C, 5D, 5E, 5F, 5G, 5H | shaft |
| 10 | battery set |
| 20 | motor |
| 25 | funnel |
| 30 | charger |
| 35 | water faucet |
| 40, 40A, 40B, 40C | transmission belt |
| 41 | check valve |
| 45L, 45R, 45AL, 45AR | pulley |
| 45BL, 45BR, 45CL, 45CR | pulley |
| 50 | water pump |
| 51A, 51B, 51C, 51D | ball valve |
| 60A, 60B, 60C | water circulator |
| 61 | safety pipe |
| 65A, 65B, 65C | impellor |
| 70A, 70B, 70C, 70D | water pipe |
| 75 | water tank |
| 80A, 80B, 80C | wind turbine |
| 85 | water pump |
| 90A, 90B, 90C | wind turbine control box |
| 95 | pump motor |
| 100 | vehicle motor |
| 105 | water wheel |
| 105A, 105B, 105C | water circulator |
| 108 | shaft of water wheel 105 |
| 110 | lighting system |
| 115 | generator |
| 118 | shaft of generator 115 |
| 120 | air-conditioning system |
| 125 | shaft |
| 127 | transmission box |
| 130A, 130B, 130C, 130D | pulley |
| 140A, 140B | v-belt connecting pulleys |

### DETAILED DESCRIPTION OF SPECIFIC EMBODIMENTS

The description above and below and the drawings of the present document focus on one or more currently preferred embodiments of the present invention and also describe some exemplary optional features and/or alternative embodiments. The description and drawings are for the purpose of illustration and not limitation. Those of ordinary skill in the art would recognize variations, modifications, and alternatives. Such variations, modifications, and alternatives are also within the scope of the present invention. Section titles are terse and are for convenience only.

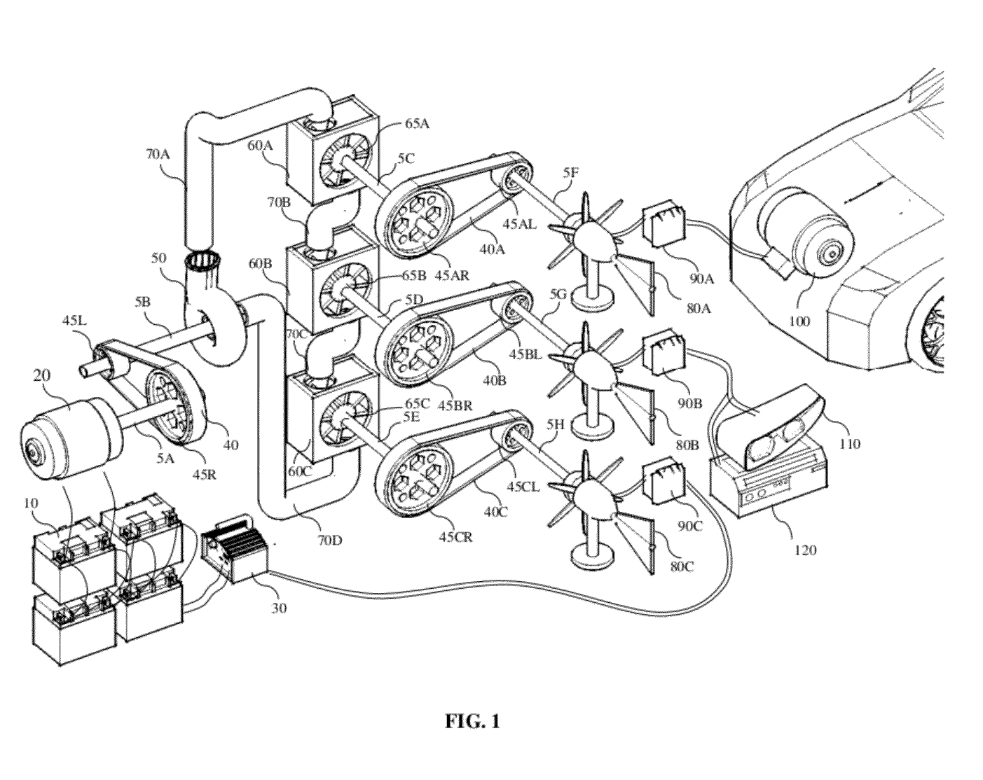

According to an embodiment of the power generator system, the system is used to propel a vehicle as illustrated in FIG. 1. As shown in FIG. 1, battery set 10, motor 20, and charger 30 together can be viewed as the system's energy source component. Motor 20 is plugged to battery set 10. Battery set 10 is connected to charger 30 for charging.

There are a set of transmission devices in this embodiment including a water pump 50, a set of water circulators 60A, 60B, 60C, a set of water pipes 70A, 70B, 70C, 70D, and a set of transmission belts 40, 40A, 40B, 40C. This set of transmission devices can be viewed as the power generator system's transmission component. Water is used as a media to transmit motion. Any other similar fluid may be used instead of water.

Motor 20 and pulley 45R of transmission belt 40 are mounted on the same shaft 5A in a fashion that when motor 20 rotates, pulley 45R follows to rotate and drives transmission belt 40 to move.

Pulley 45L and water pump 50 are mounted on the same shaft 5B in a fashion that when pulley 45L rotates, water pump 50 operates to pump water into water pipe 70A.

A water circulator is a closed box with an impeller inside and two holes on the surfaces of the box that are connected to water pipes. Water circulators 60A, 60B, and 60C have impellors 65A, 65B, and 65C inside, respectively.

Water pipe 70A connects water pump 50 and water circulator 60A as a discharge pipe of water pump 50; water pipe 70B connects water circulator 60A and 60B; water pipe 70C connects water circulator 60B and 60C; water pipe 70D connects water circulator 60C to water pump 50 as a suction pipe of water pump 50.

The connections among water pump 50, water circulator 60A, 60B, 60C, and water pipe 70A, 70B, 70C, 70D are sealed so together they compose a confined system with a certain amount of water initially provided inside. However, FIG. 1 illustrates these component connections in a partially exploded view for clarity.

As shown in FIG. 1, in this embodiment, impellor 65A in water circulator 60A and pulley 45AR of transmission belt 40A are mounted on the same shaft 5C in a fashion that when impellor 65A rotates, pulley 45AR follows to rotate and drives transmission belt 40A to move.

In the same fashion, impellor 65B in water circulator 60B and pulley 45BR of transmission belt 40B are mounted on the same shaft 5D; impellor 65C in water circulator 60C and pulley 45CR of transmission belt 40C are mounted on the same shaft 5E.

FIG. 1 shows a set of wind turbines 80A, 80B, and 80C, each with a control box 90A, 90B, and 90C, respectively. The set of wind turbines together with their control boxes can be viewed as the power generator system's power generating component.

Wind turbine 80A and pulley 45AL of transmission belt 40A are mounted on the same shaft 5F in a fashion that when pulley 45AL rotates, the rotary of wind turbine 80A follows to rotate.

In the same fashion, wind turbine 80B and pulley 45BL of transmission belt 40B are mounted on the same shaft 5G; wind turbine 80C and pulley 45CL of transmission belt 40C are mounted on the same shaft 5H.

Wind turbine 80A connects to its control box 90A. Wind turbine 80B connects to its control box 90B. Wind turbine 80C connects to its control box 90C. Wind turbine control box 90C is connected to charger 30.

This embodiment illustrates the invention adapted for use in a motor vehicle. Vehicle motor 100 propels the motor vehicle. It is connected to wind turbine control box 90A. FIG. 1 uses a sketch of car light as a symbol to represent the vehicle's lighting system 110 and uses a sketch of an air-conditioning as a symbol to represent the vehicle's air-conditioning system 120. The motor vehicle's lighting system 110 and air-conditioning system 120 are connected to wind turbine control box 90B.

### Operation

In accordance with the first embodiment of the invention shown in FIG. 1, to initialize a power generator system, one first initializes motor 20. Pump 50, water pipe 70A, 70B, 70C, 70D, and all three water circulator 60A, 60B, 60C are initiated with fluid/water at the onset, i.e. filled with fluid to allow for the pumping and circulating action. After motor 20 is initialized, one initializes vehicle motor 100.

When motor 20 is started, it drives pulley 45R to rotate. Transmission belt 40 moves following rotation of pulley 45R. Pulley 45L rotates following movement of transmission belt 40. Water pump 50 is driven to operate by rotation of pulley 45L.

When water pump 50 starts operating, water is pumped into water circulator 60A through water pipe 70A. Following water current impellor 65A inside water circulator 60A rotates. Rotation of impellor 65A drives pulley 45AR of transmission belt 40A to rotate. Transmission belt 40A moves following rotation of pulley 45AR. Pulley 45AL rotates following movement of transmission belt 40A. When pulley 45AL rotates, it drives the rotary of wind turbine 80A, which is mounted on the same shaft 5F, to rotate. Electricity is generated when rotary of wind turbine 80A rotates. The voltage and current of electricity generated from wind turbine 80A are adjusted through wind turbine control box 90A to be supplied to vehicle motor 100.

As the water current goes down from water circulator 60A to circulator 60B through water pipe 70B, the water current drives the impellor 65B inside water circulator 60B to rotate. Rotation of impellor 65B drives pulley 45BR of transmission belt 40B to rotate. Transmission belt 40B moves following rotation of pulley 45BR. Pulley 45BL rotates following movement of transmission belt 40B. When pulley 45BL rotates, it drives the rotary of wind turbine 80B, which is mounted on the same shaft 5G, to rotate. Electricity is generated when rotary of wind turbine 80B rotates. The voltage and current of electricity generated from wind turbine 80B are adjusted through wind turbine control box 90B to be supplied to the vehicle's lighting system 110 and air conditioning system 120.

As the water current goes down from water circulator 60B to water circulator 60C through water pipe 70C, the water drives impellor 65C inside water circulator 60C to rotate. Rotation of impellor 65C drives pulley 45CR of transmission belt 40C to rotate. Transmission belt 40C moves following rotation of pulley 45CR. Pulley 45CL rotates following movement of transmission belt 40C. When pulley 45CL rotates, it drives the rotary of wind turbine 80C, which is mounted on the same shaft 5H, to rotate. Electricity is generated when rotary of wind turbine 80C rotates. The voltage and current of electricity generated from wind turbine 80C are adjusted through wind turbine control box 90C to be supplied to charger 30. Charger 30 charges battery set 10 using electricity generated from wind turbine 80C.

Wind is not required as the only energy source in this embodiment of the invention. It is possible that wind turbines 80A, 80B, and 80C are operated by any or combination of motor 20 and wind.

In accordance with the first embodiment of the invention shown in FIG. 1, to stop a running power generator system, one first shuts down vehicle motor 100, then one shuts down motor 20.

The capacity of the entire power generator system can be adjusted by changing size and capacity of the motor 20, water pump 50, and wind turbines 80A, 80B and 80C. Size, shape, and capacity of transmission belts 40, 40A, 40B, 40C, pulley 45L, 45R, 45AL, 45AR, 45BL, 45BR, 45CL, 45CR, water pipe 70A, 70B, 70C, 70D should be adjusted accordingly for wind turbines 80A, 80B, 80C to provide the best performance.

Accordingly, the described power generator system can be used in vehicles, airplanes, residential houses, factories, and in other broad areas. It is easy to build and operate, without specific requirements as to location, time, and natural conditions.

Although the description above contains many specificities, these should not be construed as limiting the scope of the embodiment but as merely providing illustrations of the presently described embodiment.

For example, the transmission component can be as simple as one transmission belt connecting energy source component and power generating component; the power generating component can use wind turbines as generators but are not limited to wind turbines only; the number of motors and generators can be any combination of numbers; the media used in the circulators can be other types of fluid including air.

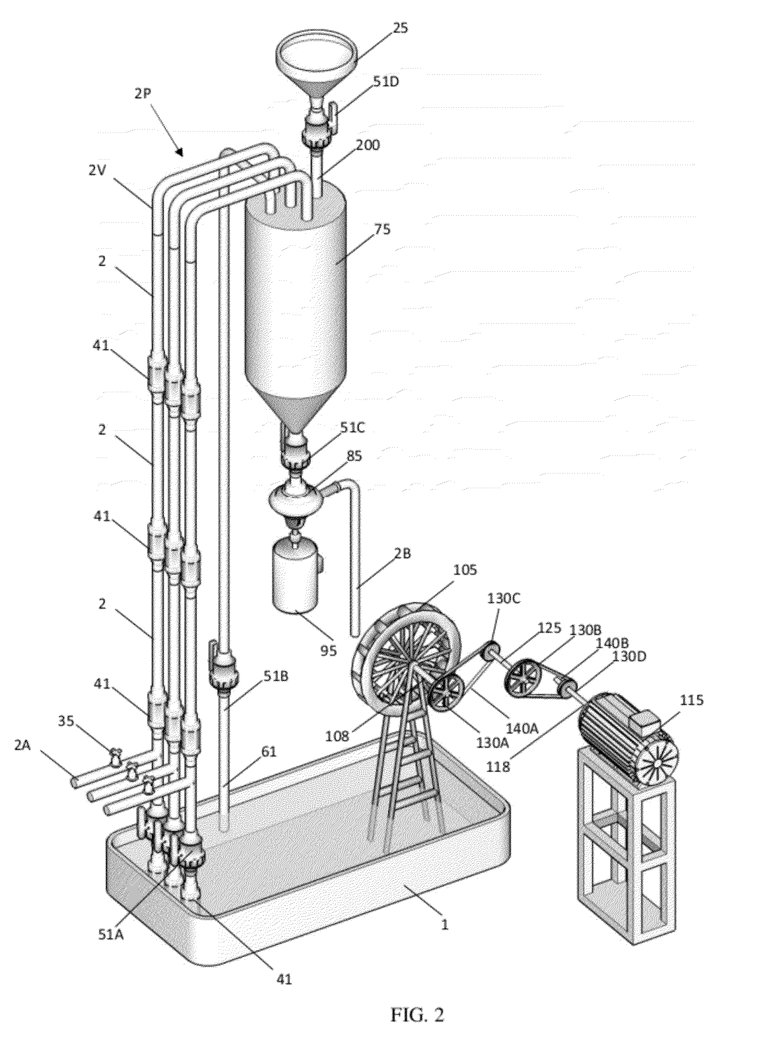

### FIGS. 2 to 4

### Alternative Embodiment

According to another embodiment of the present invention, there is a power generation system, power generator and method thereof as illustrated in FIG. 2. In this embodiment, there is a reservoir or pool 1 for holding a fluid. Pool 1 is empty at a beginning point.

Conduit 2P, such as a water pipe, is a combination of pipe segments 2 and 2A connected by check valves 41, together with ball valve 51A and faucet 35. Fluid can only flow unidirectionally, in this case flows up freely and is prevented from being able to flow down in conduit 2P. A device such as check valve 41, along the conduit 2P serves to prevent reverse flow, thereby facilitating unidirectional flow. In this embodiment, there are a plurality of conduits, for example, three conduits 2P aligned together as shown in FIG. 2. All three conduits 2P are installed vertically, with the bottom end of each conduit open to fluid pool 1.

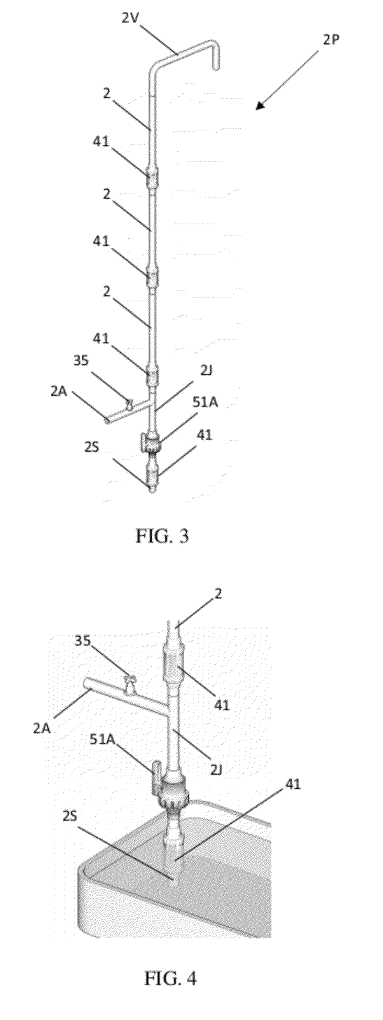

FIG. 3 shows the combination of one conduit 2P. Starting from the bottom end of conduit 2P, there is a short pipe segment 2S, a check valve 41, a ball valve 51A, and a pipe segment 2J connected vertically. On top of pipe segment 2J, there are three identical check valve 41 and three pipe segments 2 connected in an alternative fashion. Conduit 2V is a curved segment that connects the top most pipe segment 2 to fluid tank 75.

There is a level conduit 2A joining to pipe segment 2J perpendicularly. Conduit 2A has a faucet 35 that controls the fluid flow. Conduit 2A is connected to an outside fluid flow, for example a water resource such as running water. Fluid tank 75 is a container that holds fluid. Conduit 2P has its one end connected to the top surface of fluid tank 75.

Also, conduit 200 is connected to any other type of natural water resources from a higher place, such as a water fall. A ball valve 51D is installed on conduit 200 to control the flow of the water from natural resources.

Safety pipe 61 is connected to the top surface of tank 75 and it has a ball valve 51B installed on it. The lower end of safety pipe 61 is open to pool 1. The ball valve 51B is connected to the lower end of the pipe 61 to control the fluid flow to be on or off.

Fluid pump 85 has its suction pipe connected to valve 51C and its discharge end connects to pipe 2B. Pipe 2B has one end open toward water turbine or water wheel 105 such that when fluid runs out of pipe 2B, water wheel (or a water turbine) 105 starts to rotate.

In this embodiment, water wheel 105 is connected to generator 115 by a set of shafts, pulleys and belts which serves as a transmission device that transmits and accelerates rotating motion from water wheel 105 to generator 115. Water wheel 105 and pulley 130A share the same shaft 108. Pulley 130A and pulley 130C are connected by belt 140A. Pulley 130A has a bigger diameter than pulley 130C. Pulley 130C and pulley 130B share the same shaft 125. And pulley 130B is bigger than pulley 130C. Pulley 130B and pulley 130D are connected by belt 140B. Pulley 130B is bigger than pulley 130D. Pulley 130D and generator 115 share the same shaft 118.

FIG. 4 shows the details of how the lowest check valve 41, ball valve 51A, conduit 2A, and faucet 35 are positioned. The predefined level of fluid in pool 1 should be around the middle of the lowest check valve 41 of conduit 2P. A ball valve 51A is installed immediately above the lowest check valve 41. Conduit 2A, which is in connection to an outside fluid flow, is connected to conduit 2J at a location above ball valve 51A and below the second check valve 41 (i.e. the second check valve 41 being second when counting from the bottom of conduit 2P.)

### Operation

Before the power generation system is initialized there is no fluid anywhere in the system. Faucet 35, ball valve 51A on conduit 2P, ball valve 51D on conduit 200, ball valve 51B on safety pipe 61, and ball valve 51C under tank 75 are all set to be off before the system is initialized.

There are a number of scenarios where this embodiment of the power generation system can be operated. Preferably, two scenarios include with only natural fluid flow resources like water fall, or, with only running water. As the circumstances may warrant, the system may interchangeably operate between natural fluid flow and running water in a toggle fashion depending on the availability of the fluid energy source. Another working scenario would include a combination of a water fall together with running water.

In the first scenario, to turn on the system, turn on ball valve 51C and 51D and then turn on motor 95. Water from natural resources runs into funnel 25 and runs through tank 75 and fluid pump 85. When water comes out of conduit 2B, it drops on water wheel 105 and water wheel 105 starts to rotate.

The rotating motion of water wheel 105 propagates to generator 115 through shafts 108, pulley 130A, belt 140A, pulley 130C, shaft 125, pulley 130B, belt 140B, and pulley 130D. Generator 115 generates power.

In the second scenario, only running water is used as the energy source. Turning on the system comprises the following steps:

first, turn on ball valve 51B on safety pipe 61; then turn on faucet 35 on conduit 2A; after faucet 35 is turned on, outside water runs into conduit 2P, goes up through check valves 41 and pipe segments 2 and 2V, and finally runs into water tank 75 and starts to fill up water tank 75.

When tank 75 is filled, water starts to run out of safety pipe 61. When water reaches a predefined level in pool 1, first shut off faucet 35 and safety valve 51B and then turn on ball valve 51C; following that, initialize motor 95.

Once motor 95 is on, fluid pump 85 starts sucking water and bubbles out from tank 75 and sends water out from conduit 2B. When water comes out of conduit 2B, it drops onto water wheel 105 and water wheel 105 starts to rotate. The rotating motion of water wheel 105 propagates to generator 115 through shafts 108, pulley 130A, belt 140A, pulley 130C, shaft 125, pulley 130B, belt 140B, and pulley 130D. Generator 115 generates power.

Water drops into pool 1 from water wheel 105 and then gets sucked into conduits 2P and goes up into water tank 75 and falls onto water wheel 105 continuously.

By placing fluid pump 85 to pump water from tank 75, no air bubbles enter up into tank 75. Therefore, a very concentrated and strong water stream emerges out of conduit 2B. Fluid pump 85 serves to provide a suctioning effect to the emerging fluid pulled from the tank 75, thereby resulting in a suction upward through conduit 2P from pool 1 when valve 51A is in the open position.

Since this embodiment is an open system, when the system is operated under the second scenario only for a long period of time, water may be lost due to evaporation. The water level in fluid pool 1 should be maintained to reach at least the predefined level, for example, by turning on water faucet 35 for a short while. There are many conventional ways to do so for one skilled in the field. As long as some mechanism is provided to keep the water level in pool 1 at a predefined level, the system will function optimally.

Stopping the system and restoring the system to the initial status is the same under both scenarios and comprise the following:

Ensure that safety valve 51B, faucet 35, and ball valves 50A and 50D are all turned off. Next, let motor 95 run until pump 85 get all water out from tank 75 and conduit 2P and safety pipe 61. Then shut down motor 95. Once all the water is drained from pool 1, the system is back to its initial stage.

It is also possible to pause the system and resume it when needed. When pausing the system in the first scenario, shut down ball valve 51D, and then shut down motor 95. In the second scenario, shut down motor 95 only without touching any other valves. That way, all water will remain in the conduits 2P, 200, 61, and water tank 75. Due to the check valves 41 throughout conduit 2P, the fluid will remain in the conduit 2P and is prevented from flowing in an opposite direction. When resuming the system, just restart motor 95.

For conduit 2P, a reason the ball valve 51A is set above the lowest check valve 41 and below conduit 2A is to facilitate fixing the lowest check valve 41 when something needs correction. If the lowest check valve 41 does not function well, when fluid runs into the system from conduit 2A, there may be the possibility that the fluid will not go up conduit 2P.

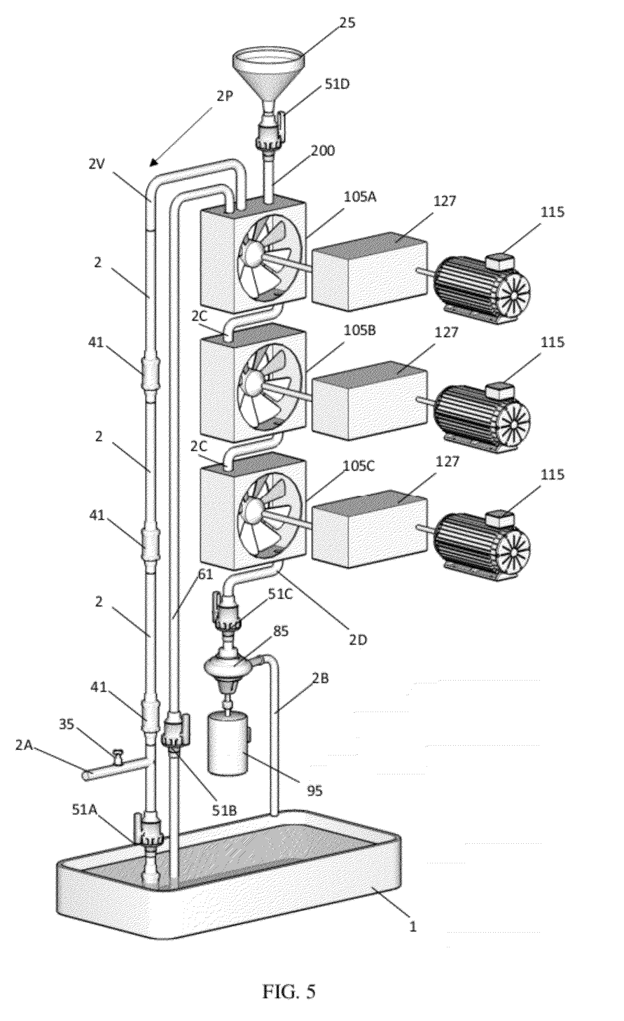

### FIG. 5

### Alternative Embodiment

FIG. 5 shows an alternative embodiment of the power generation system, power generator and method thereof.

A significant difference between the embodiment of FIG. 2 and this embodiment of FIG. 5 is that this embodiment does not use a fluid tank, nor a water wheel and simultaneously drives a plurality of generators.

As shown in FIG. 5, in this embodiment, a reservoir or pool 1, conduit 2P, and safety pipe 61 are connected in the same way as in the embodiment of FIG. 2. In this embodiment, there is shown only one conduit 2P, whereas in the embodiment of FIG. 2 there are three conduits 2P.

In this embodiment of FIG. 5, there are a one or more water circulators, for example, three water circulators 105A, 105B, and 105C. A water circulator is a closed box with an impeller inside and two holes on two ends connected to a suction pipe and/or a discharge pipe, respectively. When water is pumped into the water circulator, it drives the impellor to rotate. When the impellor rotates, the axis of the impellor follows to rotate.

The higher end of conduit 2P is connected to one open hole of the top most water circulator 105A. Funnel 25 and conduit 200 is a pipe that connects to an external water flow resource, such as a water fall.

Water circulator 105A is connected to water circulator 105B by a conduit 2C. One end of conduit 2C connects to the hole on the lower surface of water circulator 105A. Another end of conduit 2C connects to the hole on the top surface of water circulator 105B. Water circulator 105B and 105C are connected the same way.

The lower end hole of water circulator 105C is connected to conduit 2D. Conduit 2D connects to a valve 51C. Valve 51C is connected to the suction pipe of fluid pump 85. The discharge pipe 2B of fluid pump 85 is open to pool 1. The main axis of fluid pump 85 is connected to the shaft of motor 95.

Box 127 is a transmission box that can speed up the rotation speed of the shaft of water circulator 105A, 105B, and 105C. The axis of each of three water circulator 105A, 105B, and 105C is connected as input to three transmission boxes 127, respectively. One or more generators 115 are connected to the output axis of transmission boxes 127, respectively.

### Operation

In this alternative embodiment, initially, pool 1 is empty. There is no water in the system. Faucet 35, ball valve 51A on conduit 2P, ball valve 51D on conduit 200, ball valve 51B on safety pipe 61, and ball valve 51C under fluid tank 75 are all set to be off before the system is initialized.

There are a number of scenarios where this alternative embodiment of the power generation system can be operated. Preferably, two scenarios include with only natural fluid flow resources like water fall, or, with only running water. As the circumstances may warrant, the system may interchangeably operate between natural fluid flow and running water in a toggle fashion depending on the availability of the fluid energy source. Another working scenario would include a combination of a water fall together with running water.

In the first scenario, to turn on the system, turn on ball valve 51C and 51D and then turn on motor 95. Water from natural resources runs into funnel 25 and runs through water circulators 105A, 105B, 105C, and fluid pump 85. When water runs through water circulators 105A, 105B, and 105C, the shaft of each water circulator starts to rotate.

The rotational motion is propagated into transmission boxes 127 and gets accelerated. The accelerated rotational motion is finally propagated to generators 115 to generate power. The transmission box is adjusted such that the accelerated rotation makes generators 115 to reach their best performance. Water runs out from conduit 2B and falls into pool 1.

In the second scenario, only running water is used as the energy source to keep the system operating. Turning on the system comprises: turning on ball valve 51B on safety pipe 61; then turning on faucet 35 on conduit 2A; after faucet 35 is turned on, outside water runs into conduit 2P, goes up through check valves 41 and pipe segments 2 and 2V, and finally runs into water circulators 105A, 105B, and 105C to start filling up the circulators.

When the fluid/water fills up conduit 2P and circulators 105A, 105B, and 105C, water starts to run out of safety pipe 61 into pool 1. When water reaches a predefined level in pool 1, shut off faucet 35 and safety valve 51B and then turn on ball valve 51C. Following that, initialize motor 95.

Once motor 95 is on, water is sucked from water circulators 105A, 105B, and 105C, by fluid pump 85. When water runs through water circulators 105A, 105B, and 105C, the shaft of each water circulator starts to rotate. The rotational motion is propagated into transmission boxes 127 and gets accelerated. The accelerated rotation motion is finally propagated to generators 115 to generate power. The transmission box is adjusted such that the accelerated rotation allows generators 115 to reach their best performance.

Water runs out from conduit 2B and falls into pool 1. Then the water is again sucked into conduit 2P, through water circulators 105A, 105B, and 105C, continuously, keeping the system operating. Fluid pump 85 serves to provide a suctioning effect to the emerging fluid pulled through circulators 105A, 105B, and 105C, thereby resulting in a suction upward through conduit 2P from pool 1 when valve 51A is in the open position.

In the first scenario, when pausing the system, shut down ball valve 51D and turn off motor 95 while keeping all other valves at the same status. Then the system can be resumed by turning ball valve 51D on and starting motor 95 at any time.

In the second scenario, simply turning off motor 95 and turning it back on will pause and resume the system, respectively. A device such as check valve 41, along the conduit 2P serves to prevent reverse flow, thereby facilitating unidirectional flow. Due to the check valves 41 throughout conduit 2P, the fluid will be held in the conduit 2P and is prevented from flowing in an opposite direction.

In both scenarios, when stopping the system and restoring it to the initial status, turn off ball valve 51D and keep motor 95 running until all water is drained from conduit 2B. Then turn off motor 95 and drain water from fluid pool 1. That way, the system returns back to its initial stage.

Accordingly, the described embodiments of the power generation system, power generator and method thereof do not cause pollution, are easy and straightforward to build and operate, and are cost efficient and simple to maintain. In addition, the embodiments of the system can be built in desert areas. Furthermore, this invention provides flexibility for power supply. One can either use it to sustain the power demand from a range of a home to a city.

Although the description above contains much specificity, these should not be construed as limiting the scope of the embodiments but as merely providing illustrations of some of several embodiments. For example, water is easy to find and safe to use. However, other types of liquid or fluid can be used instead of water, such as oil or in other embodiments a combination with water.

Also, in the illustrated embodiment of FIG. 2, there are three conduits 2P going into the tank 75. It is envisioned that there could be more or less conduits 2P connected to tank 75. When building a conduit 2P, more pipe segments and more check valves can be used.

Moreover, in the above stated embodiment, the water wheel is connected to the generator simply by two sets of pulley and belts. It is envisioned that a sophisticated transmission system can be used to transmit the rotating motion from the water wheel to the generator, or even to more generators.

When receiving external water resources into the system, instead of using a pipe 200, there are many other ways or types of conduits to implement receiving the fluid. The shape and size of the fluid tank and funnel may widely vary.

According to some of the embodiments of an efficient power generation system and power generator, there are a number of advantages provided including: no environmental pollution caused; the power generation system is cost efficient and easy to build as well as operate; once initialized, the system is continuously operable all day, independent of the weather; the system does not require a large space for operation; and the system is easily scalable.

Throughout the description and drawings, example embodiments are given with reference to specific configurations. It will be appreciated by those of ordinary skill in the art that the present invention can be embodied in other specific forms. Those of ordinary skill in the art would be able to practice such other embodiments without undue experimentation. The scope of the present invention, for the purpose of the present patent document, is not limited merely to the specific example embodiments or alternatives of the foregoing description.

What is claimed is:

1. A power generation system, comprising:
one or more conduits for unidirectional flow, each having a first end adapted for receiving a flowing fluid energy source, and each having a second end for discharge of the fluid;
a fluid pump powered by a motor, the pump operatively connected at the second end of the one or more conduits, displacing the fluid through a discharge conduit;
a water turbine positioned below a direction of flow of the fluid from the discharge conduit;
a transmission device operatively connected with the water turbine; and
a generator operatively connected with the transmission device for generating electricity.

2. A power generation system according to claim 1, wherein at least one device for controlling the unidirectional flow is installed on the one or more conduits.

3. A power generation system according to claim 1, further comprising
a fluid tank having a receiving side coupled to each second end of the one or more conduits, the tank positioned between the second end of the one or more conduits and to a receiving end of the pump;
a reservoir positioned to receive the fluid flowing off from the water turbine; and
wherein at least one of the one or more conduits is configured to have a third end in fluid connection with the reservoir for receiving a fluid from the reservoir, such that as the pump displaces the fluid from the fluid tank through the discharge conduit, the fluid in the reservoir is pulled through the third end for release back into the tank.

4. A power generation system according to claim 3, wherein one of the one or more conduits is a receiving funnel capturing naturally flowing fluid into the fluid tank.

5. The power generation system according to claim 3, further comprising a safety conduit having a first end in fluid connection with the tank and a second end for release of fluid into the reservoir once the fluid in the tank reaches a fill level.

6. The power generation system according to claim 5, wherein the conduit having a third end comprises a device located above the third end to control the fluid from the reservoir to flow unidirectionally into the third end of the conduit from the reservoir; and the first end of each of the one or more conduits is positioned at a higher elevation than the third end.

7. A power generation system, comprising:
one or more conduits for unidirectional flow, each having a first end adapted for receiving a flowing fluid energy source, and each having a second end for discharge of the fluid;
at least one fluid circulator having a receiving end connected to each second end of the one or more conduits, and a discharge end;
a fluid pump powered by a motor, the pump operatively connected at the discharge end of the at least one fluid circulator, the pump displacing the fluid flowing through the fluid circulator and through a discharge conduit coupled to the pump;
a transmission device operatively connected with the fluid circulator; and
a generator operatively connected with the transmission device for generating electricity.

8. A power generation system according to claim 7, wherein at least one device for controlling the unidirectional flow is installed on the one or more conduits.

9. A power generation system according to claim 7, wherein one of the one or more conduits is a receiving funnel capturing naturally flowing fluid for discharge into the at least one fluid circulator.

10. A power generation system according to claim 7, further comprising
a valve coupled to the discharge end of the fluid circulator and to a receiving end of the pump;
a reservoir positioned to receive the fluid flowing out from the fluid circulator and
wherein at least one of the one or more conduits is configured to have a third end in fluid connection with the reservoir for receiving a fluid from the reservoir, such that as the pump displaces the fluid from the fluid circulator through the discharge conduit, the fluid in the reservoir is pulled through the third end for release back into the receiving end of the fluid circulator.

11. The power generation system according to claim 10, further comprising a safety conduit having a first end in fluid connection with the fluid circulator and a second end for release of fluid into the reservoir once the fluid in the fluid circulator reaches a fill level.

12. A power generation system, comprising:
at least one fluid circulator receiving pumped fluid at a receiving end and releasing the fluid from a release end;
a fluid pump coupled to a conduit in connection with the receiving end of the at least one fluid circulator, the pump having a receiving end for receiving the fluid released from the at least one fluid circulator, the pump operated by a motor;
a transmission device operatively connected with the at least one fluid circulator;
at least one wind turbine operatively connected with the transmission device; and
at least one generator operatively connected with the at least one wind turbine for generating electricity.
